(19) United States
(12) Patent Application Publication
(10) Pub. No.: US 2014/0071100 A1
(43) Pub. Date: Mar. 13, 2014

(54) ERGONOMIC STYLUS WITH AN INFLATABLE FINGER GRIP

(71) Applicant: Viler Andres Becerra Figueroa, Miramar, FL (US)

(72) Inventor: Viler Andres Becerra Figueroa, Miramar, FL (US)

(21) Appl. No.: 14/021,870

(22) Filed: Sep. 9, 2013

Related U.S. Application Data
(60) Provisional application No. 61/699,812, filed on Sep. 11, 2012.

(51) Int. Cl. G06F 3/0354

(52) U.S. Cl. CPC G06F 3/03545
USPC 345/179

(57) ABSTRACT

An ergonomic stylus for operating a mobile device is disclosed. In one embodiment, the ergonomic stylus includes a stylus point, an inflatable finger grip and a fluid injection system. The inflatable finger grip includes an inflatable layer. The fluid injection system is employed to inflate the inflatable layer. The disclosed ergonomic stylus is convenient to use and may be easily docked with the mobile device when not in use. The ergonomic stylus compllies with ergonomics principles. The ergonomic stylus further includes a telescopic extension to adjust the length of the ergonomic stylus.

### RELATED APPLICATIONS

This application is based on and claims priority from Provisional Application Ser. No. 61/699,812 filed Sep. 11, 2012.

### TECHNICAL FIELD

Embodiments of the present disclosure relates in general to a stylus for computers with pen-based interfaces. In particular, the invention relates to an ergonomic inflatable finger grip stylus that is more convenient to use.

### BACKGROUND

Nowadays mobile devices technology is advancing in an unprecedented way. More and more people are using these devices in daily life. Most modern mobile devices are equipped with touch screens, which are largely operated using fingers. Due to the popularity of these devices, developers are now developing very sophisticated applications for the mobile devices which include engineering applications, technical design, artistic drawing, spread sheet applications, stock market application etc. Currently, most users use their fingers to interact with the touchscreen devices, which is not as comfortable as it causes strain in the fingers and the wrist, thereby decreasing productivity. In addition, while using just hands, the hand may block view of a large section of the touch screen. It is also difficult to use touchscreen with longer fingernails or fat fingers. Further, in cold weather, users are not able to use touchscreen wearing gloves.

A stylus is a writing tool, which is often used to achieve smooth writing, drawing or working on the touch screen devices. The stylus is often better than fingers as it is more comfortable, more precise, and easier to control. A stylus lets a user type just as fast (and maybe faster) than he can type with his fingers on a touch screen and it allows for fine-motor skills like drawing and photo editing. In addition, handwriting is more flexible as it is easier to enter stuff like equations, arrows, and smiley faces that are not available on a standard keyboard. The use of stylus is also more hygienic as users do not touch the touch screens directly with their fingers, which may be dirty. Further, the stylus does not block view of a large section of the touch screen and users may use while wearing gloves.

However, existing styluses are not ergonomic enough. Most do not fulfill at least one of the two main principles of ergonomic writing instruments, namely, the ease to grip the stylus using three fingers; thumb, index finger, middle finger and that the stylus body rests on the union of thumb and index finger. For example, some styluses are too short which do not rest on the union of thumb and index. Further, the existing styluses are not very portable as they are big, chunky and in most cases larger that the mobile device, making the stylus difficult to carry along with the device. The user has to carry the stylus separately in a purse, bag, etc. Thus, a need remains for a stylus that overcomes the problems according to prior art as described above.

### SUMMARY

An ergonomic stylus for operating a mobile device comprising a stylus point, an inflatable finger grip including an inflatable layer and a fluid injection system to inflate the inflatable layer. The ergonomic stylus further comprising a telescopic extension for increasing and decreasing the length of the ergonomic stylus. The inflatable finger grip is independent of the fluid injection system. The inflatable finger grip includes an internal body, placed inside of the inflatable layer, which in turn is placed inside an external body. The fluid injection system injects a fluid into the internal body; the fluid comes out thorough a plurality of first vent holes in the internal body to inflate the inflatable layer, the inflatable layer then pops up through a plurality of second vent holes in the external body. The style point includes a fluid valve regulator to allow a fluid to get out and deflate the inflatable finger grip.

An ergonomic stylus for operating a mobile device comprising an inflatable finger grip including an inflatable layer and a fluid injection system to inflate the inflatable layer. When in use the circumference of the ergonomic stylus is such that it is easy to grip the stylus using three fingers including the thumb, the index finger and the middle finger and the length of the ergonomic stylus is such that the stylus body rests on the union of the thumb and the index finger of a user.

An object is to provide an ergonomic inflatable finger grip stylus for use as a portable stylus, for mobile devices, that comply with ergonomics principles.

Another object is to provide an Ergonomic Inflatable Finger Grip Stylus that gives enough portability, which means that the stylus can be docked to a mobile device, or docked inside on a mobile device.

Another object is to provide an Ergonomic Inflatable Finger Grip Stylus that can be combined, attached, assemble, mixed etc to another standard stylus features.

Another object is to provide an Ergonomic Inflatable Finger Grip Stylus that avoids tiredness and cramps on palm and wrist after some period of activity due to dispersion of pressure along the hand.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE FIGURES

FIG. 1 illustrates a side view of a stylus according an embodiment of present disclosure.

FIG. 2 illustrates a perspective view of the stylus according an embodiment of present disclosure.

FIG. 3 illustrates a perspective view of the stylus according an embodiment of present disclosure.

FIG. 4 illustrates a perspective view of the stylus according an embodiment of present disclosure.

FIG. 5 illustrates a perspective view of the stylus according an embodiment of present disclosure.

FIG. 6 illustrates an exploded perspective view of the stylus in accordance with some embodiments.

FIG. 7 illustrates a perspective view of an inflatable finger grip of the stylus in accordance with some embodiments.

FIG. 8 illustrates a perspective view of the inflatable finger grip of the stylus in accordance with some embodiments.

FIG. 9 illustrates a side view of the finger grip in accordance with some embodiments.

FIG. 10 illustrates a side view of the finger grip in accordance with some embodiments.

FIG. 11 illustrates a side view of the finger grip in accordance with some embodiments.

FIG. 12 illustrates a side view of the finger grip in accordance with some embodiments.

FIG. 13 illustrates a side view of the finger grip in accordance with some embodiments.

FIG. 14 illustrates a side view of the finger grip in accordance with some embodiments.

FIG. 15 illustrates a side view of the finger grip in accordance with some embodiments.

FIG. 16 illustrates a side view of the finger grip in accordance with some embodiments.

FIG. 17 illustrates a side view of the finger grip in accordance with some embodiments.

FIG. 18 illustrates a side view of the finger grip in accordance with some embodiments.

FIG. 19 illustrates a first stage of deployment in accordance with some embodiments.

FIG. 20 illustrates a second stage of deployment in accordance with some embodiments.

FIG. 21 illustrates a third stage of deployment in accordance with some embodiments.

FIG. 22 illustrates a fourth stage of deployment in accordance with some embodiments.

FIG. 23 illustrates a pump mechanism to inflate the inflatable layer in accordance with some embodiments.

FIG. 24 illustrates a pump mechanism to inflate the inflatable layer in accordance with some embodiments.

FIG. 25 illustrates a beach ball inflation mechanism to inflate the inflatable layer in accordance with some embodiments.

FIG. 26 illustrates a beach ball inflation mechanism to inflate the inflatable layer in accordance with some embodiments.

FIG. 27 illustrates a stylus point in accordance with some embodiments.

FIG. 28 illustrates a stylus point in accordance with some embodiments.

FIG. 29 illustrates a stylus point in accordance with some embodiments.

FIG. 30 illustrates a stylus point in accordance with some embodiments.

While the invention is amenable to various modifications and alternative forms, specific embodiments are shown by way of example in the drawings and are described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION

### Overview

In the following description, numerous specific details are set forth to provide a thorough understanding of the present disclosure. However, it will be clear to one skilled in the art that the present disclosure may be practiced without some or all of these details. In other instances, well known process steps have not been described in detail in order to avoid unnecessarily obscuring the present disclosure.

An ergonomic stylus for operating a mobile device is disclosed. In one embodiment, the ergonomic stylus includes a stylus point, an inflatable finger grip and a fluid injection system. The inflatable finger grip includes an inflatable layer. The fluid injection system is employed to inflate the inflatable layer using a fluid. The fluid is any substance that has no fixed shape and yields easily to external pressure such a gas or a liquid. The disclosed ergonomic stylus is convenient to use and may be easily docked with the mobile device when not in use.

### Ergonomic Inflatable Finger Grip Stylus

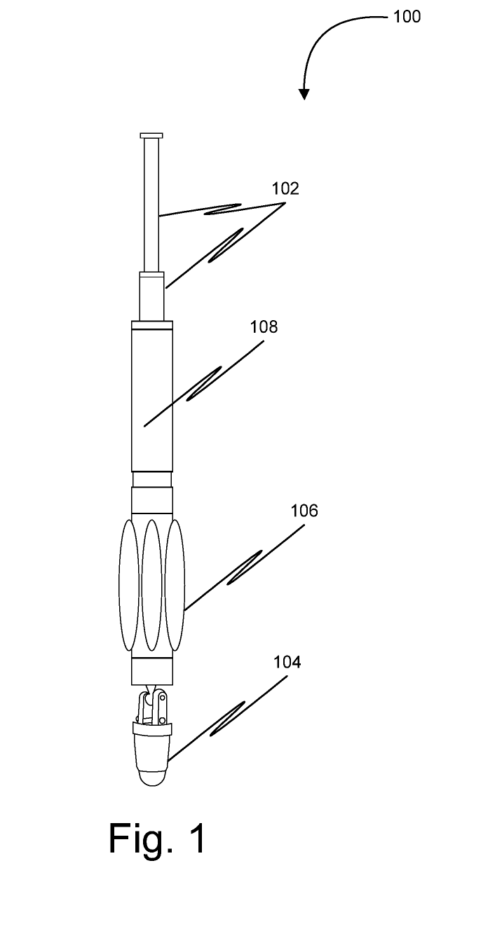

FIG. 1 illustrates a side view of a stylus 100 according an embodiment of present disclosure. The stylus 100 has a telescopic extension 102, a mobile head point 104, an inflatable finger grip 106 and a fluid injection system 108. The body of the stylus 100 may be made from one or more materials including but not limited to plastic, aluminum, steel, rubber etc.

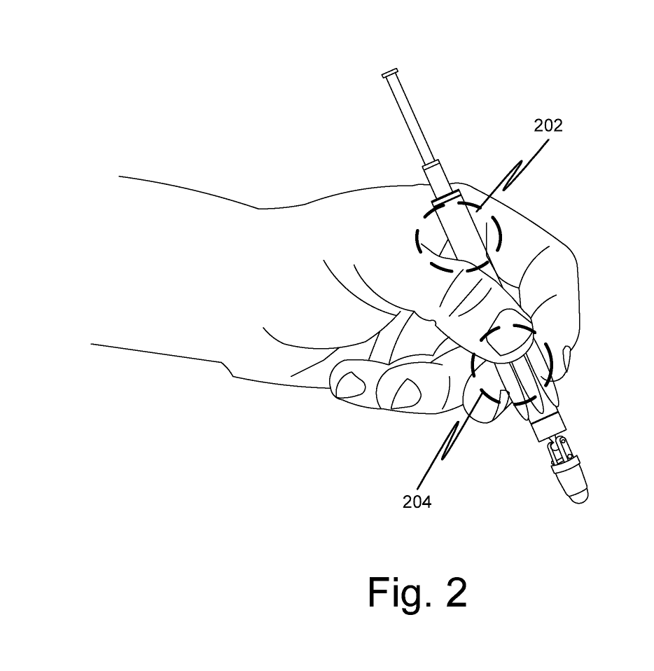

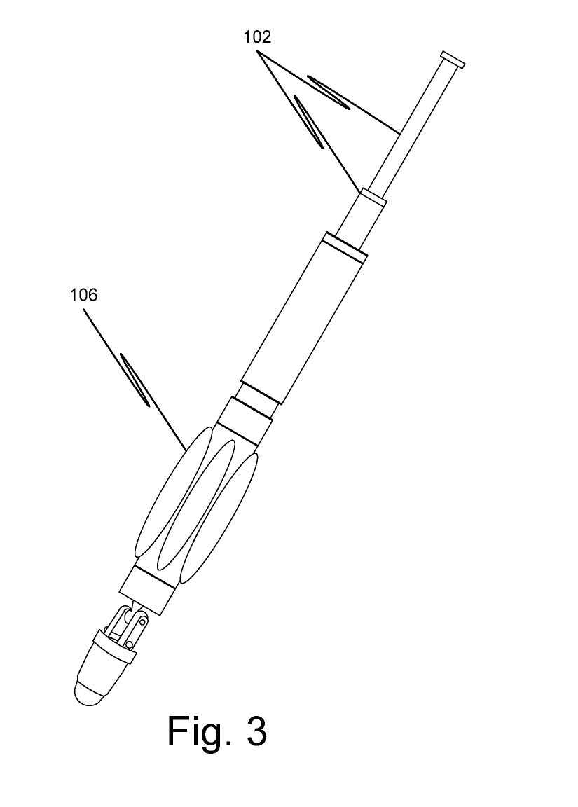

A user may increase the length of the stylus 100 by extending the telescopic extension 102 while using the stylus 100. This enables the stylus 100 to comply with an ergonomic principle that the stylus body should rest on the union of thumb and index. This is explained in further detail in conjunction with FIG. 2 below. Further, the user may collapse the telescopic extension 102 to shorten the length of the stylus 100 to increase portability of the stylus 100. This is explained in further detail in conjunction with FIGS. 3-5 below.

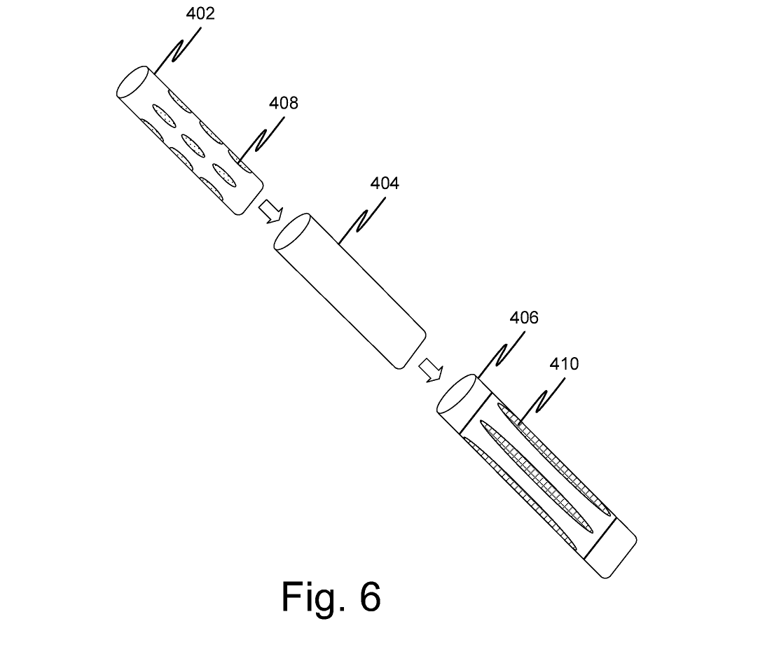

The stylus 100 may be have any length, circumference or transversal area and shape, whose inflatable finger grip 106 can be enhanced by any fluid. The fluids continually deform (flow) under an applied shear stress. The fluids include liquids, gases, plasmas and even some plastic solids. Further, an inflatable layer of the inflatable finger grip 106 may be made from one or more materials including but not limited to rubber, latex, vinyl, silicon, expansible polymer, neoprene etc. The inflatable finger grip 106 is explained in further detail in conjunction with FIGS. 6-18 below.

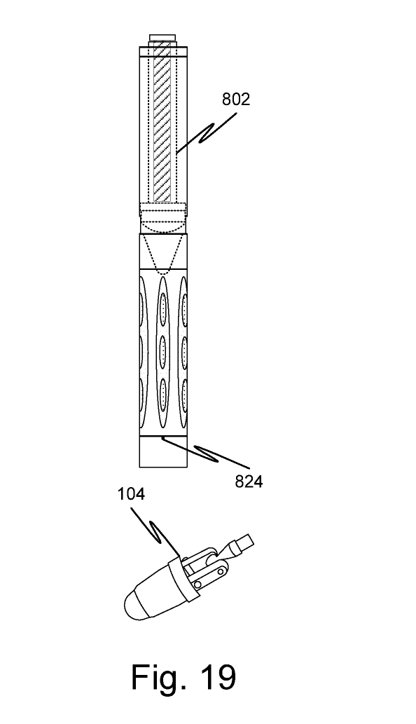

The fluid injection system 108 is used to inflate the inflatable layer of the inflatable finger grip 106. The fluid injection system 108 is explained in further detail in conjunction with FIGS. 19-26 below. It may be noted that the inflatable finger grip 106 is independent of the fluid injection system 108 used in the stylus 100.

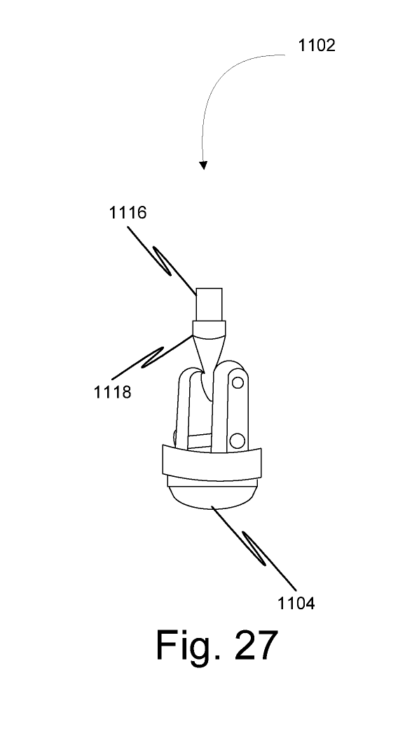

When a user uses the stylus 100, the stylus point 104 provides the user a smooth writing experience similar to using a ballpoint pen. The style points may have different point sizes, point textures etc. Further, the stylus point 104 may be a fixed stylus point or an interchangeable stylus point. The interchangeable stylus points enable a user to change the stylus point based on a specific requirement. This is explained in further detail in conjunction with FIGS. 27-30 below. The stylus point 104 also helps in securely docking the stylus 100 with a mobile device, as the stylus point 104 is wider than the body of the stylus 100.

The stylus point 104 may also acts as a fluid valve regulator that allows the fluid to get out when the user wants to deflate the inflatable finger grip 106. This is explained in further detail in conjunction with FIGS. 19-22 below.

The telescopic extension 102, the stylus point 104, the inflatable finger grip 106 and the fluid injection system 108 may be made, combined, attached or assembled using various techniques and materials known in the art. Further, additional features including but not limited to laser geospatial pointers, Wi-Fi transmitters, lighting etc. may be deployed on the stylus 100.

FIG. 2 illustrates a perspective view of the stylus 100 according an embodiment of present disclosure. The telescopic extension 102 is extended, which gives the stylus 100 adequate length such that the stylus body rests on the union of thumb and index as shown by a dotted circle 202. This is an optimal ergonomic position due to dispersion of pressure along the hand avoiding tiredness and cramps on palm and wrist after some period of activity.

Further, the inflatable finger grip 106 has adequate circumference that enables a user to easily grip the stylus 100 using three fingers; thumb, index, middle as shown by dotted circle 204. For example, the circumference of the inflatable finger grip 106 may be between the circumference of thumb and pinky fingers.

### Docking the Stylus

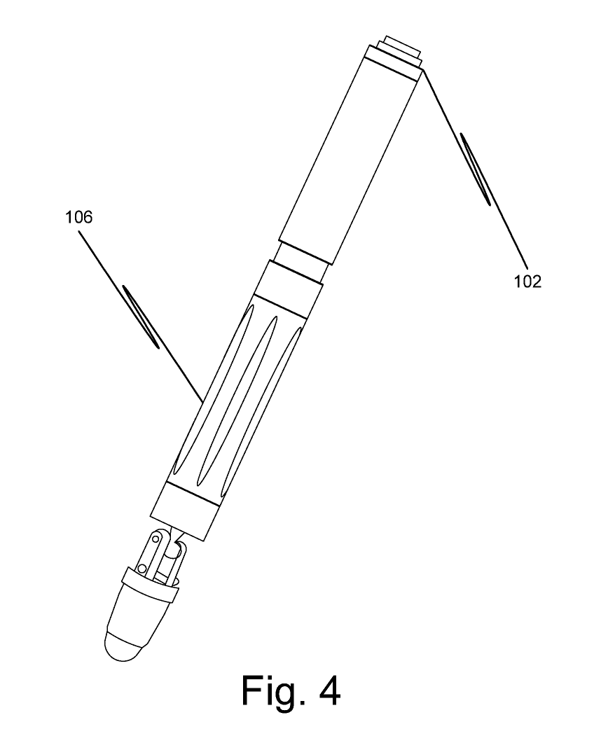

FIG. 3 illustrates a perspective view of the stylus 100 according an embodiment of present disclosure. The stylus 100 has an extended telescopic extension 102 and an inflated inflatable finger grip 106. The telescopic extension 102 may be collapsed to decrease the length of the stylus 100 and the inflatable finger grip 106 may be deflated as shown in FIG. 4. For example, the stylus 100 shown in FIG. 3 may have length of 110 mm and circumference of 44 mm. When the stylus 100 is collapsed as shown in FIG. 4, the length decreases to 60 mm and the circumference decreases to 24 mm.

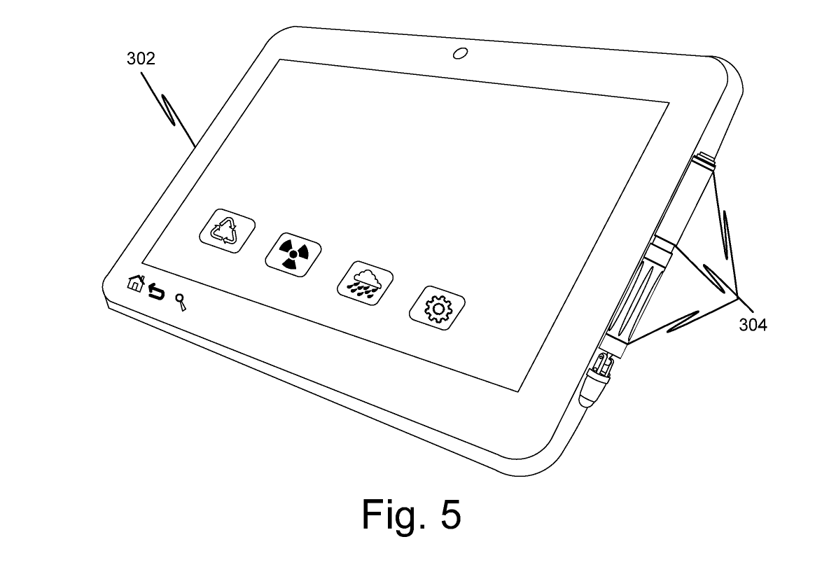

Then, the stylus 100 may be docked with a mobile device 302 as shown in FIG. 5. Further, the length and transversal area of the stylus 100 may be small in order to be placed inside of the mobile device 302 or they may be bigger that allows the stylus 100 to be docked externally to the mobile device 302 using any known mechanism including but not limited to magnetic and mechanical fasteners. For example, the stylus 100 may be magnetically attached to the mobile device 302 using magnetic rings 304 attached to the mobile device 302.

### Inflatable Finger Grip

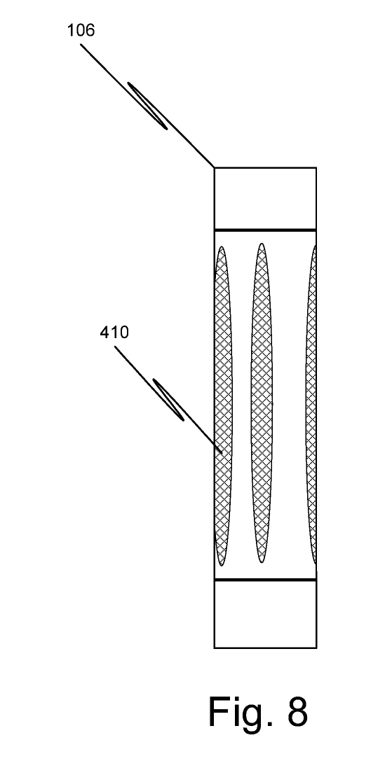

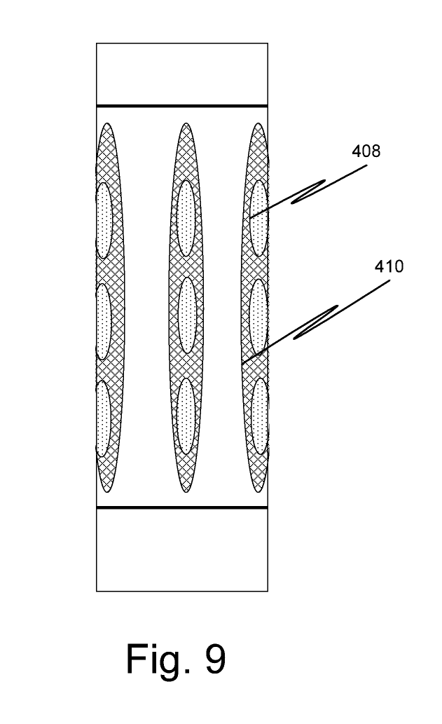

FIG. 6 illustrates an exploded perspective view of the inflatable finger grip 106 according an embodiment of the present disclosure. An internal body 402 is placed inside of an inflatable layer 404, which in turn is placed inside of an external body 406. The internal body 402 and the external body 406 may be made from one or more materials including but not limited to aluminum, steel, plastic, carbon, etc. The inflatable layer 404 may be made from one or more materials including but not limited to rubber, latex, vinyl, silicon, expansible polymer, neoprene etc. The fluid is injected into the internal body 402, which comes through first vent holes 408 in the internal body 402. The fluid injection system is explained in further detail in conjunction with FIGS. 8, 9 and 10 below. The fluid from the first vent holes inflates the inflatable layer 404, which then pops up through the second vent holes 410 in the external body 406. The inflated layer 404 that pop us through the second vent holes 410 forms elongated bubbles which provide a soft yet high friction grip on the stylus 100 to a user holding the stylus 100. The shape of the bubbles may change based on the shape of the vent holes. This is explained in further detail in conjunction with FIGS. 9-14 below.

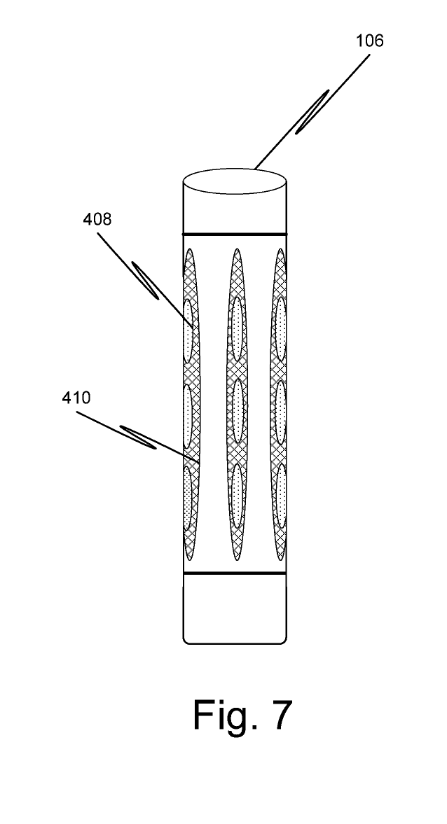

FIG. 7 is a transparent view of the inflatable finger grip 106 showing the first vent holes 408 and the second vent holes 410, when the internal body 402 is placed inside the inflatable layer 404, which is then placed inside an external body 406. FIG. 8 shows actual (non-transparent) side view of the inflatable finger grip 106.

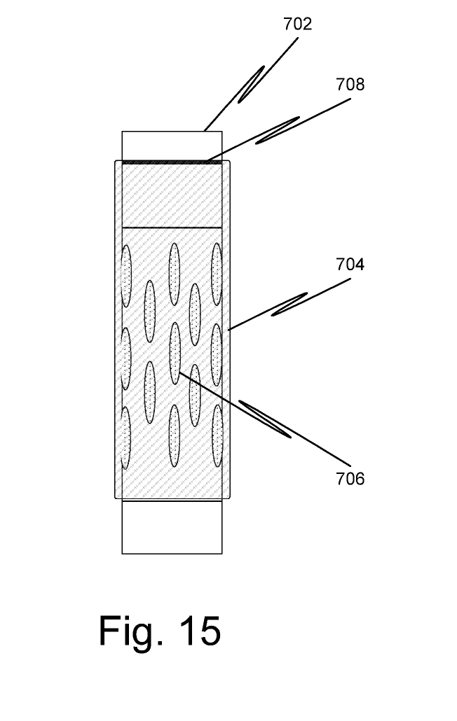

The inflatable finger grip 106 shown in FIG. 6 uses three layers—the internal body 402, the inflatable layer 404 and the external body 406. However, fewer than three layers may be used. For example, two layers may be employed, wherein a shape-shifting part that returns to its original shape after deflation is used. This is explained in further detail in conjunction with FIGS. 15-18 below.

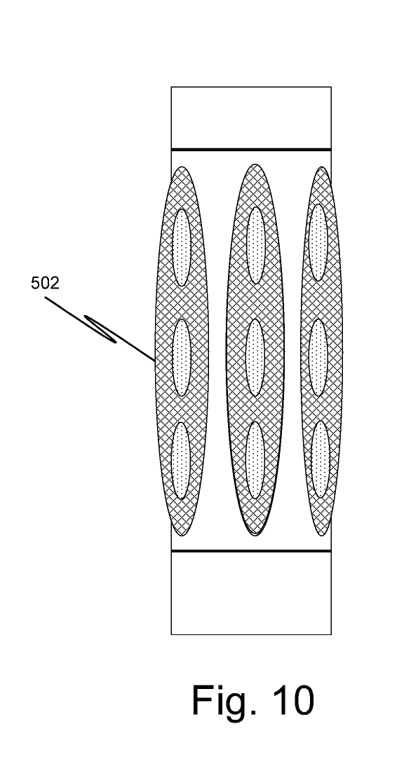

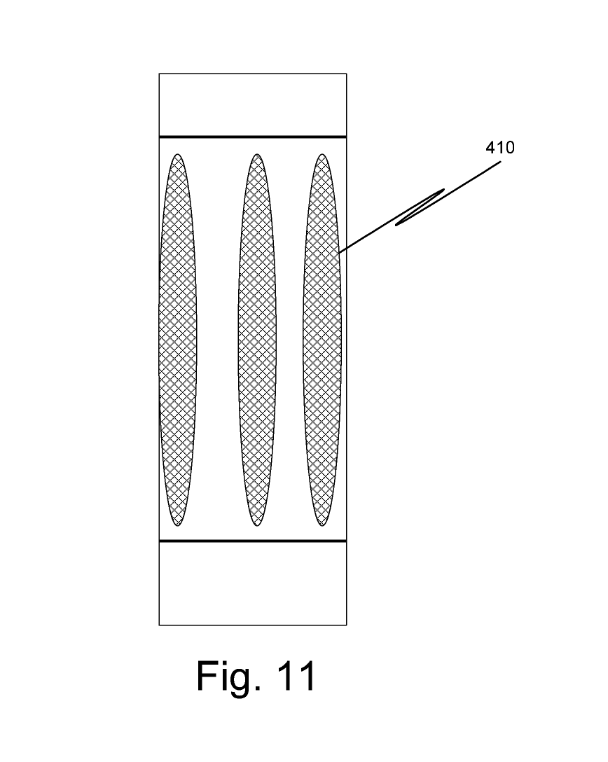

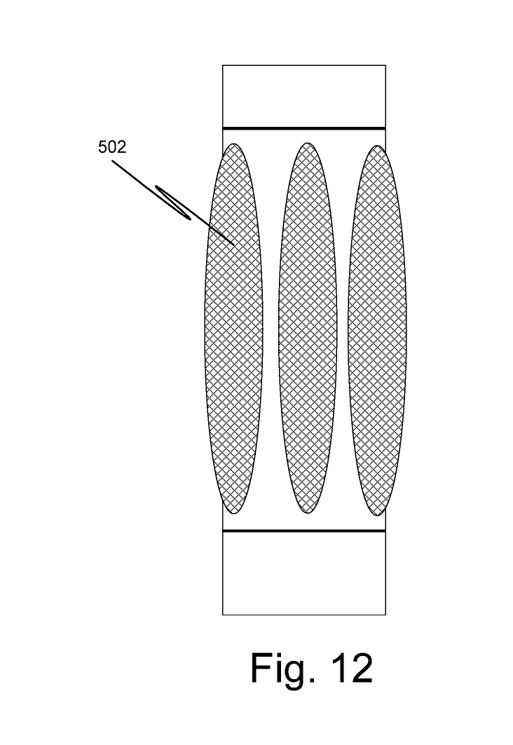

FIG. 9 shows a transparent view of a deflated finger grip 106 and FIG. 11 shows an actual view (non-transparent) view of the deflated covered finger grip 106 in accordance with an embodiment. The second vent holes 410 in the external body 406 are oval shaped; therefore, when the inflated layer 404 protrudes out of the holes 410 it forms elongated bubbles 502 as shown in FIGS. 10 and 12. FIG. 10 shows a transparent view of the inflated transparent finger grip 106 and FIG. 12 shows an actual (non-transparent) view of the inflated transparent finger grip 106. The elongated bubbles 506 allow a user to get a good grip on the stylus 100.

An external fluid injection system may be used to inflate the inflatable layer 404 using a fluid. The excess of fluid inside the internal body 402 tends to find any way to expand, through the fluid vent holes 408, and in this way the fluid try to flow outside using the way of less resistance; in this case the inflatable layer 404, which then protrudes out to form the elongated bubbles 502. The fluid injection system is explained in detail in conjunction with FIGS. 19-26 below.

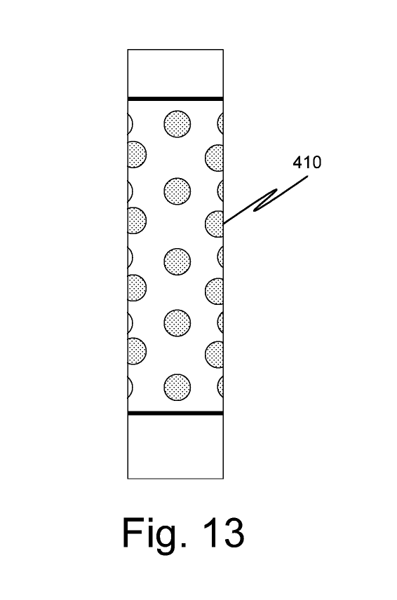

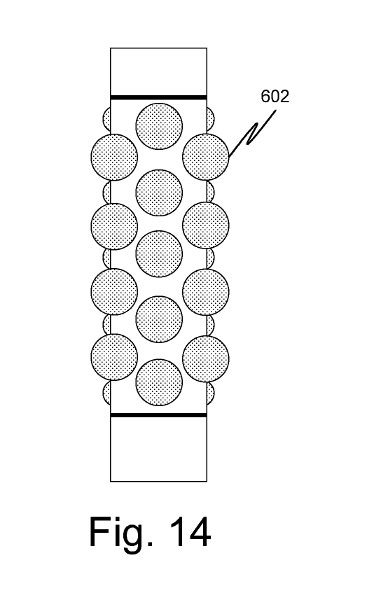

FIG. 13 shows a deflated finger grip of the stylus 100 in accordance with an embodiment. The second vent holes 410 are round shaped; therefore, when inflated the inflated layer protrudes out of the round holes to form round bubbles 602 as shown in FIG. 14.

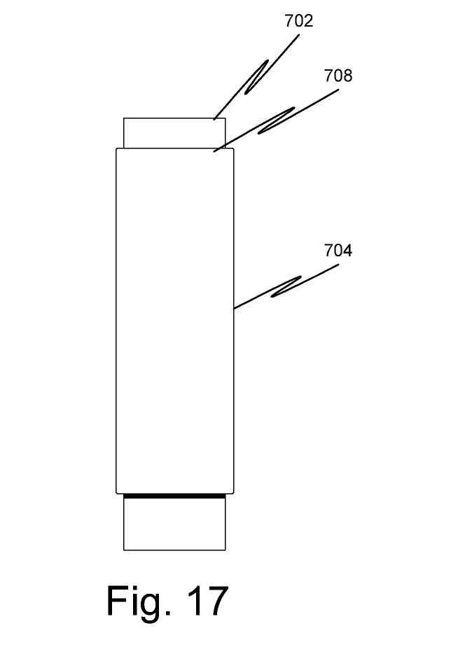

FIG. 15 shows a transparent view of a deflated finger grip and FIG. 17 shows an actual (non-transparent) view of the deflated finger grip in accordance with an embodiment. In this embodiment, the finger grip includes an internal body 702 and an inflatable layer 704. However, it may not have any external body.

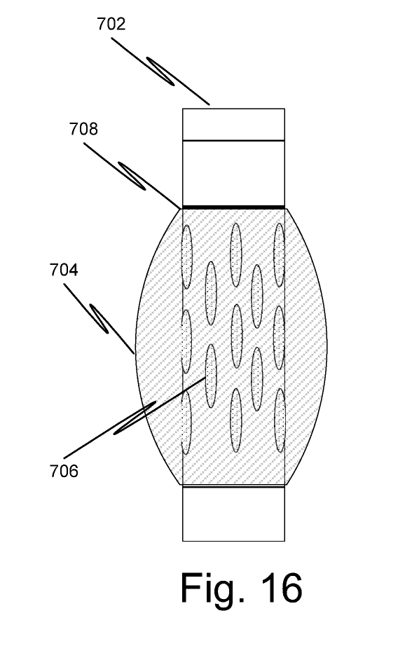

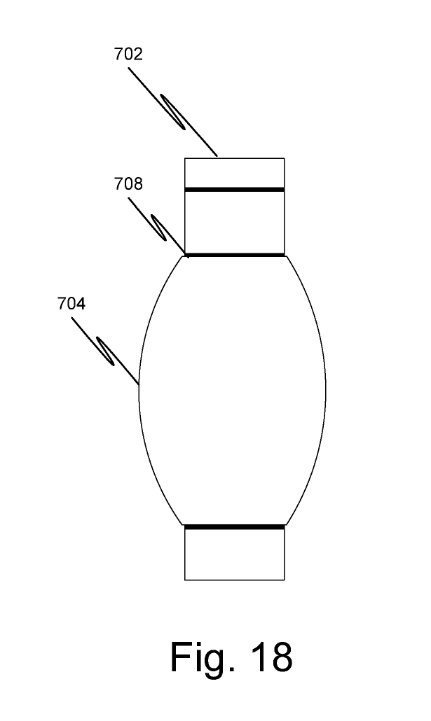

When fluid is injected in the internal body 702, it comes out of the vent holes 706 and inflate the inflatable layer 704. During inflation, a part of the inflatable layer 704 is moved down and secured by a secure ring 708, in order to create a better ergonomic contour on the inflated inflatable layer 704, as shown in FIGS. 16 and 18. FIG. 16 shows a transparent view of the inflated finger grip and FIG. 18 shows an actual (non-transparent) view of the inflated covered finger grip 107 of the stylus 700. When deflated, the secure ring 708 moves up back to the original position.

### Fluid Injection System

FIGS. 19, 20, 21 and 22 illustrate various stages of deployment of a fluid injection system 108 in accordance with an embodiment. In this embodiment, the fluid injection system 108 uses a syringe method to inject a fluid to inflate the inflatable finger grip 106.

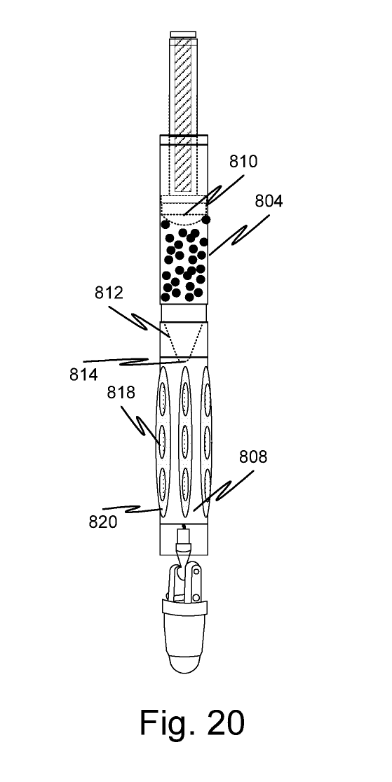

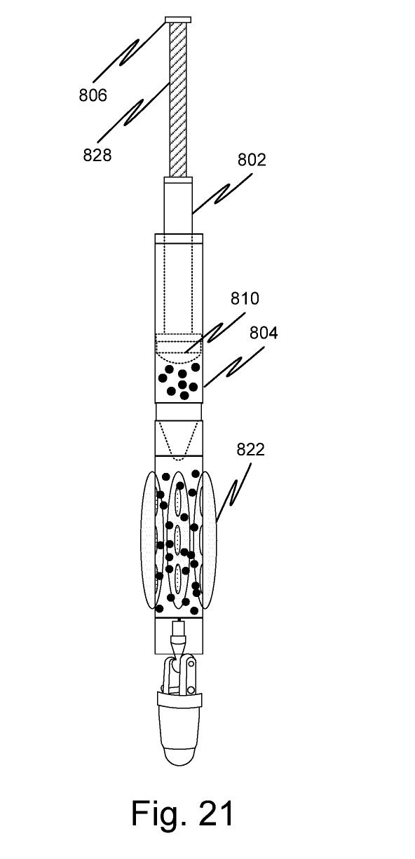

FIG. 19 illustrates a first stage of deployment in which the stylus 100 in an initial position. Next, a stylus point 104 may be deployed and a plunger 802 may be pulled back to fill a barrel 804 with air (or any other fluid) as shown in FIG. 20 (a second stage of deployment). Next, a user uses a thumb rest 806 to push the plunger 802 downwards. The plunger 802 includes a plunger head 810 that fits snugly against the walls of the barrel 804, making an airtight seal. The plunger head 810 may be made from one or more materials including but not limited to rubber. The plunger head 810 pushes the air down through an injector 812 and an injector hole 814 into a fluid chamber 808 (similar to the internal body 402 of FIG. 6). The excess air comes out of vent holes 818 (similar to first vent holes 408) and inflates the inflatable layer (similar to the inflatable layer 404) which protrudes out from vent holes 820 (similar to the second vent holes 410) to form elongated bubbles 822 as shown in FIG. 21 (a third stage of deployment). The elongated bubbles 822 provide a soft yet high friction grip on the stylus 100 as described earlier.

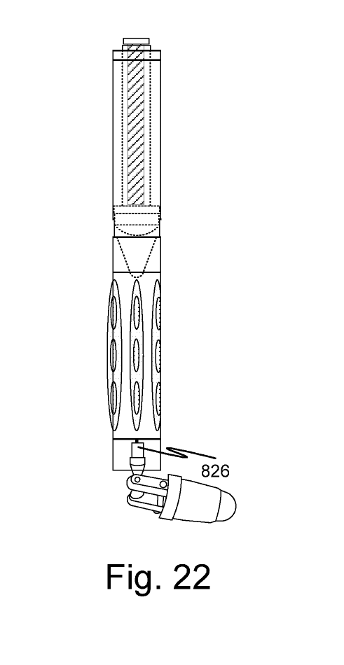

The stylus point 104 also acts as a fluid release cap on a top end of a fluid release valve 824. The stylus point 104 may be attached to the fluid release valve 824 using any known technique; for example, a screw seal system 826. When required, a user may release the air from the fluid chamber 808 and the inflatable layer using the stylus point 104 as shown in FIG. 22 (a fourth stage of deployment).

The stylus 100 also includes a telescopic bar 828, which increases the length of the stylus 100 such that the stylus 100 rests on the union of thumb and index of the user.

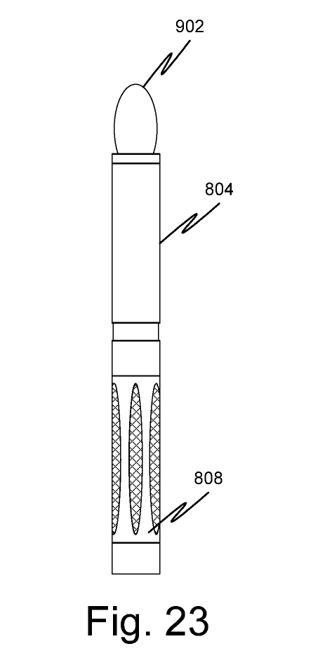

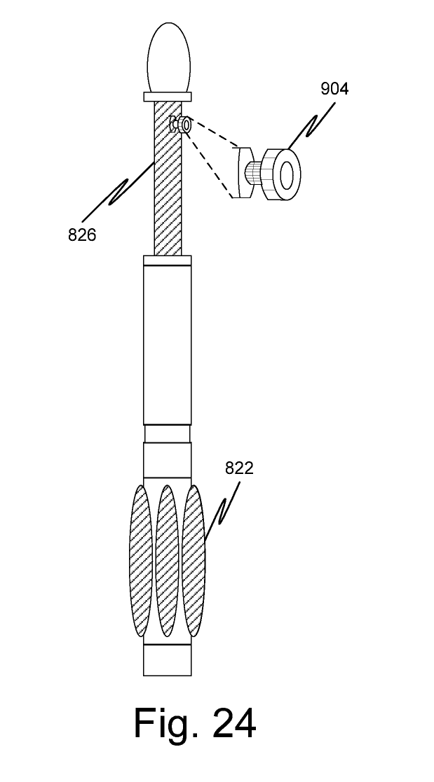

FIGS. 23 and 24 illustrate a fluid injection system 108 in accordance with another embodiment. In this embodiment, the fluid injection system 108 uses a pump mechanism to inject the fluid and inflate the inflatable layer in the inflatable finger grip 106. The other functional parts of the stylus are same as described in detail in conjunction with FIGS. 19-22 above. FIG. 23 illustrates a pump bulb 902 containing the fluid. A user may squeeze the pump bulb 902 to inject the fluid into the barrel 804 and then into the fluid chamber 808 by squeezing the pump bulb 902. The injected fluid inflates the inflatable layer which protrudes out to form to form the elongated bubbles 822 as shown in FIG. 24. The fluid release may be regulated by a pressure control valve 904.

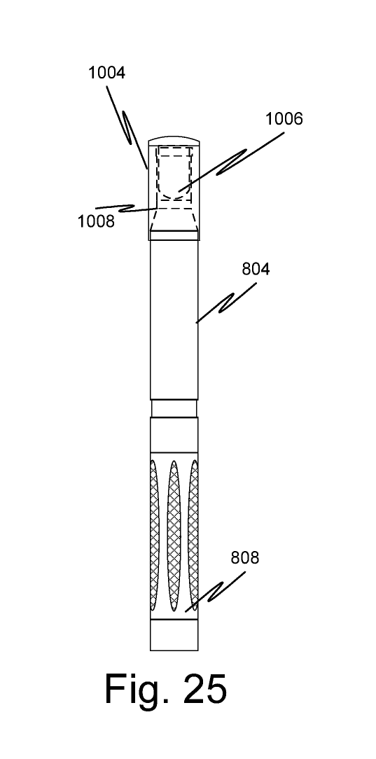

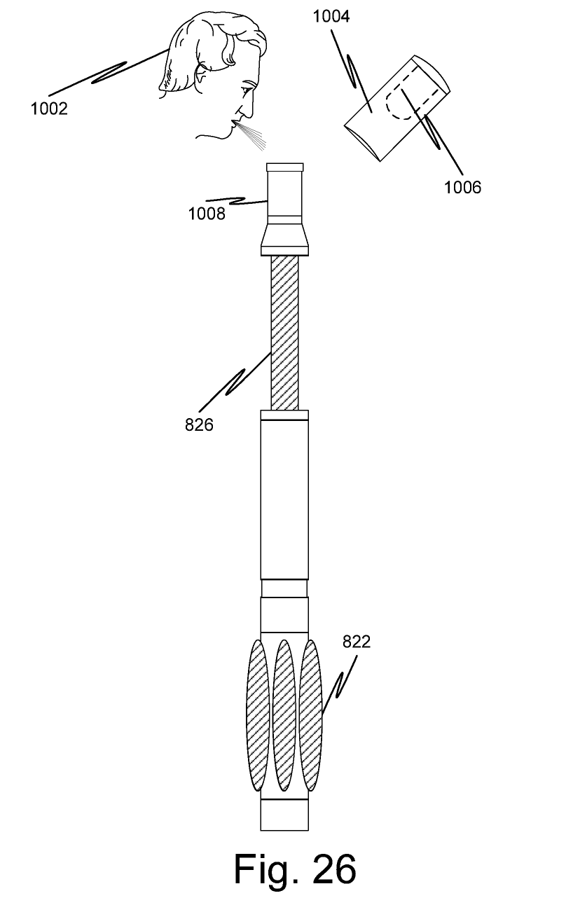

FIGS. 25 and 26 illustrate a fluid injection system 108 in accordance with yet another embodiment. In this embodiment, the fluid injection system 108 uses a beach ball inflation mechanism to inject the fluid to inflate the inflatable layer in the inflatable finger grip 106. The other functional parts of the stylus shown in FIGS. 25-26 are same as described in detail in conjunction with FIGS. 19-22 above. A user 1002 may blow air into a valve 1008 which is injected into the barrel 804 and then into the fluid chamber 808. The injected fluid inflates the inflatable layer which protrudes out to form to form the elongated bubbles 822 as shown in FIG. 26. Then, a cap 1004 is placed in order to fit a seal plug 1006 inside the valve 1008. The mechanism to release air (the fluid) includes removing the cap 1004, thereby disengaging the seal plug 1006 from the valve 1008.

### Stylus Point

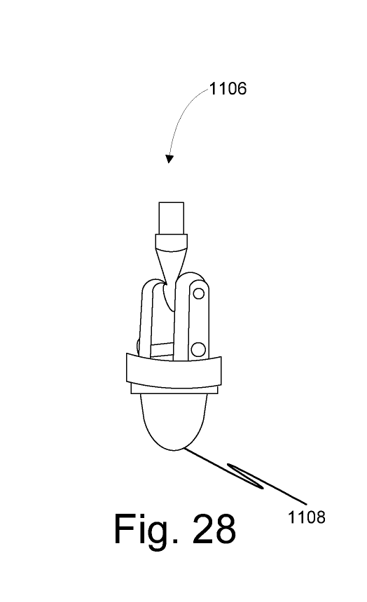

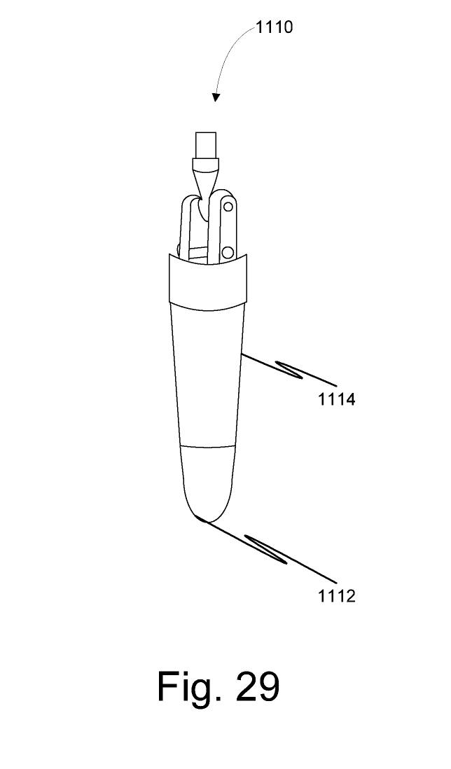

FIGS. 27-30 illustrate various types of stylus points in accordance with some exemplary embodiments. The stylus 100 may have fixed stylus points or interchangeable stylus points. The interchangeable stylus points enable a user to change the style point based on a specific requirement. The style points may have different points sizes, point textures, special position point slab etc. As shown in FIG. 27, the stylus point 1102 has a flat point head 1104, the stylus point 1106 (shown in FIG. 28) has a sharper point head 1108 and the stylus point 1110 (shown in FIG. 29) has a still sharper point head 1112. An artist may prefer to use the stylus point 1110 for performing finer modifications in the drawings.

Further, the stylus points may or may not have a grip for a user to hold the stylus 100. For example, the stylus 1110 has a grip 1114 that may be used by a user to hold the stylus 100. The stylus points may also be used to dock the stylus 100 internally or externally on the mobile device 302.

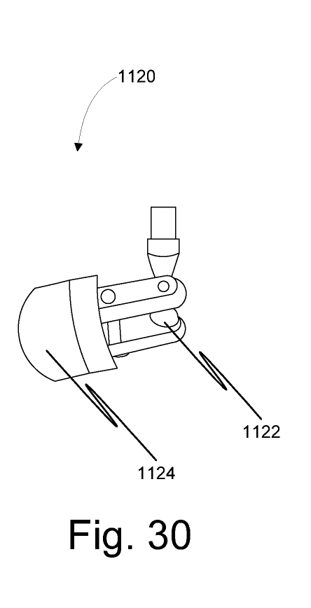

A fluid screw top 1116 may be attached to a fluid release valve 824 as shown in FIG. 21 above. An “o” seal ring 1118 acts as a seal to impede loss or leak of the fluid when a stylus point is attached. Other seal systems or techniques like pressure seal systems, docking seal systems etc. may also be used. A stylus point 1120 (shown in FIG. 30) may have a spherical join elbow 1122, which allows a user to adjust an angle of a point head 1124 as per user convenience.

The stylus 100 may use various other types of stylus points. For example, stylus points may be made of one solid piece with stylus body. Further, they may or may not include a valve release.

The specification has described ergonomic inflatable stylus. The terms, descriptions and figures used herein are set forth by way of illustration only and are not meant as limitations. It should be anticipated that ongoing technological development will change the manner in which particular functions are performed. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the invention.

1. An ergonomic stylus for operating a mobile device comprising:
a stylus point;
an inflatable finger grip including an inflatable layer; and
a fluid injection system to inflate the inflatable layer.

2. The ergonomic stylus of claim 1, further comprising a telescopic extension for increasing and decreasing the length of the ergonomic stylus.

3. The ergonomic stylus of claim 1, wherein the inflatable layer is made from one or more of rubber, latex, vinyl, silicon, expansible polymer and neoprene.

4. The ergonomic stylus of claim 1, wherein the inflatable finger grip is independent of the fluid injection system.

5. The ergonomic stylus of claim 1, wherein the style point is interchangeable.

6. The ergonomic stylus of claim 1, wherein the style point includes a fluid valve regulator to allow a fluid to get out and deflate the inflatable finger grip.

7. The ergonomic stylus of claim 1, wherein the ergonomic stylus is docked with the mobile device, wherein one or more of the length and circumference of the ergonomic stylus is adjusted to dock the ergonomic stylus internally or externally with the mobile device.

8. The ergonomic stylus of claim 1, wherein the inflatable finger grip includes an internal body, placed inside of the inflatable layer, which in turn is placed inside an external body.

9. The ergonomic stylus of claim 8, wherein the internal body and the external body are made from one or more of aluminum, steel, plastic and carbon.

10. The ergonomic stylus of claim 9, the fluid injection system injects a fluid into the internal body, the fluid comes out thorough a plurality of first vent holes in the internal body to inflate the inflatable layer, the inflatable layer then pops up through a plurality of second vent holes in the external body.

11. The ergonomic stylus of claim 10, wherein the shape of the first vent holes and second vent holes is one of a round shape and an oval shape.

12. The ergonomic stylus of claim 1, wherein the fluid injection system is syringe system to inject a fluid to inflate the inflatable finger grip.

13. The ergonomic stylus of claim 12, wherein the syringe system includes a plunger installed in a barrel in the ergonomic stylus, wherein the plunger is pushed down to inject the fluid in the barrel into the inflatable finger grip.

14. The ergonomic stylus of claim 1, wherein the fluid injection system includes a pump bulb containing a fluid, wherein pump bulb is squeezed to inject the fluid to inflate the inflatable layer in the inflatable finger grip.

15. The ergonomic stylus of claim 1, wherein the fluid injection system uses a beach ball inflation mechanism to inject the fluid to inflate the inflatable layer in the inflatable finger grip.

16. The ergonomic stylus of claim 14, wherein a user blows air into a valve to inflate the inflatable layer in the inflatable finger grip.

17. The ergonomic stylus of claim 1, wherein when in use the circumference of the ergonomic stylus is such that it is easy to grip the ergonomic stylus using three fingers including the thumb, the index finger and the middle finger and the length of the ergonomic stylus is such that the ergonomic stylus rests on the union of the thumb and the index finger of a user.

18. An ergonomic stylus for operating a mobile device comprising:
an inflatable finger grip including an inflatable layer; and
a fluid injection system to inflate the inflatable layer;
wherein when in use the circumference of the ergonomic stylus is such that it is easy to grip the ergonomic stylus using three fingers including the thumb, the index finger and the middle finger;
wherein when in use the length of the ergonomic stylus is such that the ergonomic stylus rests on the union of the thumb and the index finger of a user.

19. The ergonomic stylus of claim 18, wherein the inflatable finger grip includes an internal body, placed inside of the inflatable layer, which in turn is placed inside an external body; wherein the fluid injection system injects a fluid into the internal body, the fluid comes out thorough a plurality of first vent holes in the internal body to inflate the inflatable layer, the inflatable layer then pops up through a plurality of second vent holes in the external body.

20. An ergonomic stylus of claim 18, wherein when in use the length of the ergonomic stylus is 110 mm and the circumference of the ergonomic stylus is 44 mm; wherein when not in use the length of the ergonomic stylus is 60 mm and the circumference of the ergonomic stylus is 24 mm.
